(19) United States
(12) Patent Application Publication
(10) Pub. No.: US 2006/0086811 A1
(43) Pub. Date: Apr. 27, 2006

(54) Bar code

(76) Inventors: Minoru Yoshida, Fujisawa City (JP); Takamitsu Kamakura, Yokohama City (JP); Yoshinori Hiraide, Tokyo (JP); Kazuya Muto, Fujisawa City (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/261,119

(22) Filed: Oct. 27, 2005

(30) Foreign Application Priority Data
Oct. 27, 2004 (JP) 2004-312334

(51) Int. Cl. G06K 19/06

(52) U.S. Cl. 235/494

(57) ABSTRACT

A design bar code 100 according to one particular embodiment includes a bar symbol sequence 110 that contains a plurality of bar symbols aligned in a scanning direction X with spaces therebetween, and an additional pattern 130 that supplements a pattern represented by the outer shape of the bar symbol sequence 110. The length of one or more bar symbols in a direction Y is defined so as to have a contour forming at least a portion of a rendered pattern. The additional pattern 130 may positioned as necessary in the region outside of the belt area 112 so as to supplement the pattern represented by the outer shape of the bar symbol sequence 110.

### FIELD OF THE INVENTION

The present invention relates to machine-readable bar codes and methods of configuring bar codes.

### BACKGROUND OF THE INVENTION

A bar code can be used to store information that is readable by machines, including alphanumeric information, by combining a plurality of bar symbols and spaces therebetween. A bar code described in, for instance, Japanese Patent Application Laid-Open Publication 2001-273470, is able to indicate as many as A multiplied by B types of information, wherein A stands for level of tone and B stands for width of each bar symbol. A bar code capable of expressing much more information may be attained using such a technique.

However, typical bar codes including the conventional bar codes described above are configured solely to provide information that is detected by machines such as bar code scanners. The bar codes themselves do not provide a visual impression of any kind to users. Moreover, these non-appealing bar codes tend to occupy substantial areas of packages or product surfaces.

### BRIEF SUMMARY

Described herein are design bar codes, products and product packaging with bar codes, and methods of constructing bar codes that are capable of creating a visually perceptible impression to users, while at the same time expressing information that can be detected by machines, such as bar code scanners. In one embodiment, a design bar code comprises a bar symbol sequence that includes a plurality of bar symbols aligned with spaces therebetween and a side having human-readable bar code information. The bar symbols occupy a belt area and one or more of the bar symbols has a length that extends outside of the belt area. The length of at least one bar symbol in the bar symbol sequence is varied in a region outside of the belt area to form a rendered pattern, the region outside of the belt area being opposite the side of the barcode having the human-readable bar code information. At the same time, the bar symbols inside the belt area represent information that is machine readable.

In another embodiment, the length of multiple bar symbols in the bar symbol sequence described above are varied to form an outer shape of the rendered pattern in the region outside of the belt area.

Further, in another embodiment, an additional pattern is linked to at least one of the bar symbols in the region outside of the belt area.

In yet another embodiment, at least one of the bar symbols in the plurality of bar symbols is disconnected in the region outside of the belt area.

In still another embodiment, the design bar code further comprises a color pattern configured to be read by machine as a background color. The color pattern may be linked to at least one of the bar symbols in the region inside of the belt area.

Thus, a design bar code as disclosed herein not only functions to provide information that is machine-readable, but also functions to deliver information that is visually appealing to users.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a view for explaining the construction of a design bar code pertaining to an embodiment of the present invention;

FIG. 2 illustrates an outer appearance of a product package with a design bar code pertaining to an embodiment of the present invention;

FIG. 3 provides a view of example design bar codes pertaining to an embodiment of the present invention;

FIG. 4 provides another view of example design bar codes pertaining to an embodiment of the present invention; and

FIG. 5 provides a view of yet another example of a design bar code pertaining to an embodiment of the present invention.

### DETAILED DESCRIPTION

Exemplary embodiments are described herein with reference to the accompanying drawings, though it should be understood that the scope of the claimed invention is not limited to the precise features, forms, and/or steps described herein. The scope of the claimed invention is determined from the claims appended hereto and equivalents thereof.

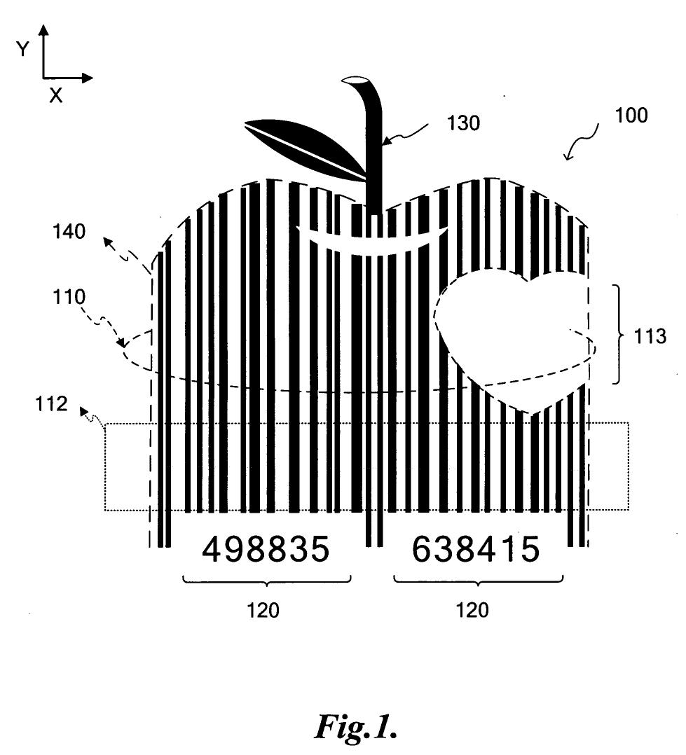

FIG. 1 shows a layout view of a design bar code of an embodiment pertaining to one mode for carrying out the invention. A design bar code 100 in this particular embodiment comprises a plurality of bar symbols with intervening spaces therebetween that are aligned in a scanning direction X. An additional pattern 130 is shown supplementing the pattern represented by the outer edges of the bar symbol sequence 110. Human readable bar code information 120 (e.g., a start character, stop character, check digit and the like) is shown written along a side of the bar code 100 in the scanning direction X.

The bar symbols that comprise the bar symbol sequence 110 are configured to occupy a belt area 112 that is virtually defined and shown in FIG. 1 along the scanning direction X and a lateral direction Y. The size of the belt area 112 is defined according to particular performance requirements and standards of the bar code scanners that are used to read the bar code. The length of each bar symbol in the direction Y is generally equal to or more than the length in the direction Y of the belt area 112.

In the belt area 112, machine-readable information is defined by a combination of the width of the bar symbols in the X direction and the spaces therebetween. A design bar code of the present embodiment thus functions as a machine-readable bar code. For purposes of example only, and without limitation to the present invention, the size of a bar code expressed as the length in direction X multiplied by the width in direction Y of the belt area 112 may be one of 3.73 cm×2.66 cm, 2.99 cm×2.13 mm and 2.67 cm×2.20 mm, or could be made smaller for instance, around 9 mm in the Y direction, or larger in either direction if needed, considering factors such as the size of the available print space, provided the bar symbols inside the belt area 112 represent information that is machine-readable.

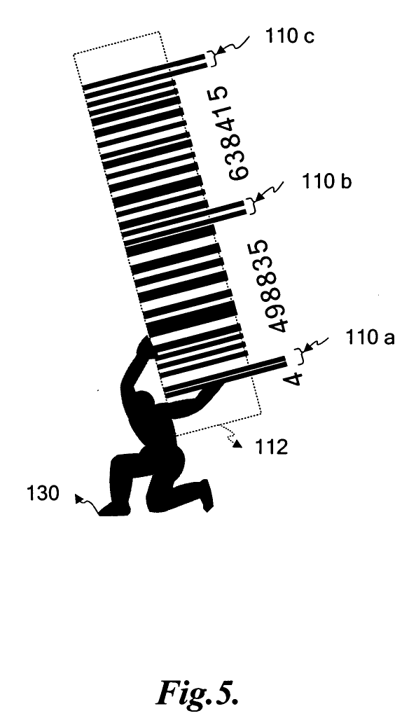

As discussed earlier, a bar code may include human readable bar code information 120 placed adjacent to a side of the belt area 112. The bar code information 120 may be separated by extensions of the bar symbols in the sequence 110. For example, a left guard bar 110a, a center bar 110b, and a right guard bar 110c are depicted in FIG. 5 to separate portions of the bar code information 120. The bar code information 120 and the bar extensions 110a, 110b, and 110c do not constitute part of the present invention.

According to the present invention, the end portions of each bar symbol constituting the bar code sequence 110 above the belt area 112 may be modified to represent any shape. That is, the portions of the bar symbols outside the machine-readable area of the bar code and opposite the side having the bar code information 120 can take an unprescribed form. As shown in FIG. 1, in the region outside of the belt area 112, an outer appearance of the bar symbol sequence 110 is defined by the length of the bar symbols in the Y direction. A contour 140 surrounding the bar symbol sequence allows at least a portion of the shape to be rendered. FIG. 1 further depicts a region 113 in which the bar symbols are disconnected to form another pattern. In some embodiments, the end portion of one or more of the bar symbols may be linked so as to allow contact in the contour 140 of the pattern.

The additional pattern 130 (referenced above) can be placed in the region outside of the belt area 112 as desired in order to supplement the pattern represented by the contour 140 of the bar symbol sequence 110. Such an additional pattern 130 can be linked to one or more of the bar symbols in the region outside of the belt area 112, or may be placed without contacting the bar symbols. An overall rendered pattern including the bar symbol sequence 110 is thus obtained.

While each of the bar symbols generally takes a rectangular shape in FIG. 1, the bar symbols can take any shape in the region outside of the belt area 112. For instance, the width of a bar symbol can be varied for any of the bar symbols outside the belt area 112, or any of the bar symbols may be curved or distorted.

A visual image thus intended by a designer or the like can result from the shape rendered by the design bar code 100. The design bar code 100 pertaining to the embodiment shown in FIG. 1 not only functions to provide information readable by bar code scanners or other machines, but also functions as a unique design element that delivers visually perceptable information to users. Accordingly, a design bar code having a unified impression with the package of the product and/or expressing a property of the product, does not diminish or distract from the image of the product. The design of the product or package is enhanced, even when the space allocated for the bar code on the package is significant. Moreover, an impression of the product may more effectively appeal to users by adjusting the size or position of the bar code in accordance with the product or package design.

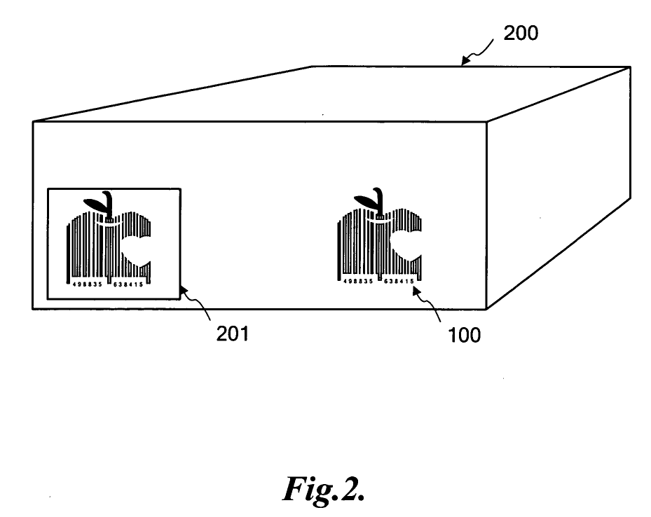

FIG. 2 depicts the outer appearance of a product or product package provided with the design bar code of FIG. 1. A design bar code 100 may be directly printed on a product or package 200, or printed on a label 201 to be attached to the product or the package, in a manner for instance as shown in FIG. 2. The bar code can be applied to any product or product package as far as the product or the package permits the use of bar codes as an information-bearing medium.

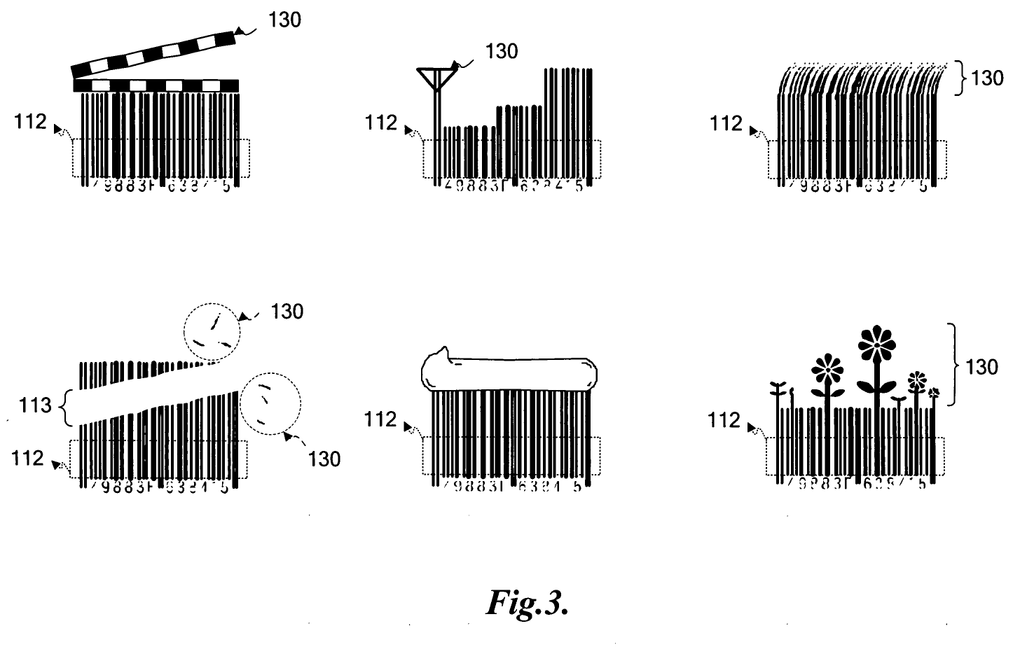

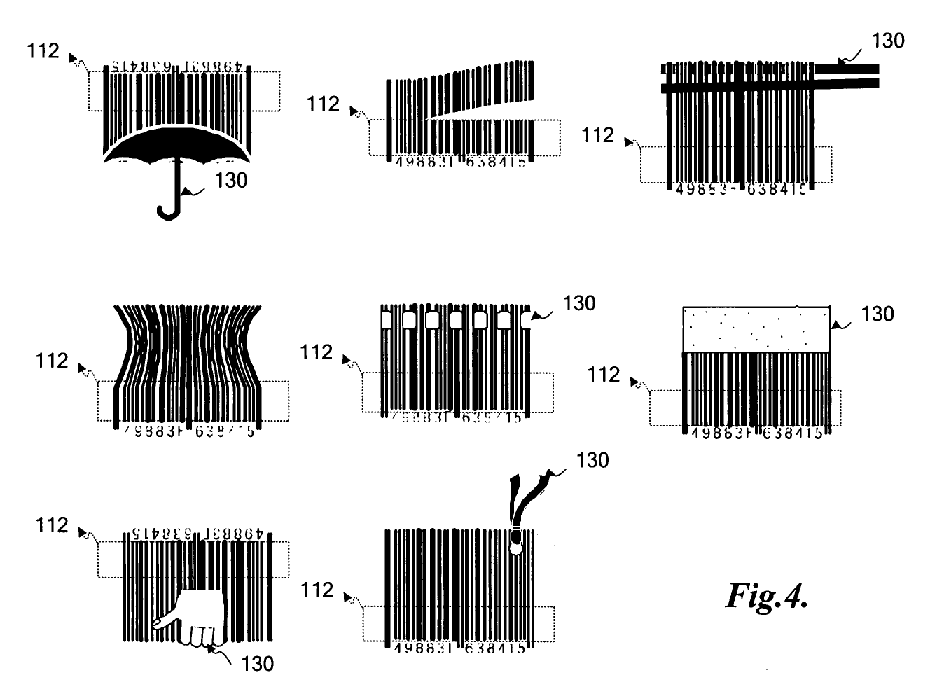

A design bar code having a contour configured to indicate a fruit, for example, has been described above and shown in FIGS. 1 and 2. However, design bar codes pertaining to the present embodiment should not be construed to limit the scope of the claimed invention. A design bar code may be configured using the invention herein and adopt various designs such as those shown in FIGS. 3 and 4, for example, by considering the desired impression of the product or other factors. In FIGS. 3 and 4, design bar codes are shown with additional patterns 130 and disconnected patterns 113 as described above. Also shown by dotted lines in FIGS. 3 and 4 are the virtual belt areas 112, though in practice such dotted lines are not included in the design bar codes.

In the above-described embodiments, the additional patterns 130 are placed outside the region of the belt area 112. However, a pattern is not required to be placed as such, and could constitute part of the image inside the belt area 112, provided that the readability of information by bar code scanners is not interrupted. For example, as shown in FIG. 5, when the additional pattern 130 has a color that a bar code scanner identifies as a background color, such additional pattern can be drawn in a manner that appears to link to the bar symbols. A background color is one that typically reflects a beam irradiated by the bar code scanner at an intensity greater than the intensity of objects to be identified as bar code symbols. In such cases, depending upon the content of the pattern represented by the combination of the bar symbol sequence 110 and the additional pattern 130, patterns other than prescribed bar symbols may be linked to the bar symbols inside the belt area 112.

Further contemplated by the invention herein is a method of constructing a design bar code as described above. In one embodiment, the method comprises preparing a bar symbol sequence 110 that includes a plurality of bar symbols aligned with spaces therebetween and a side having human-readable bar code information 120. The bar symbols occupy a belt area 112 and one or more of the bar symbols has a length that extends outside of the belt area. The method further includes varying the length of at least one bar symbol in the bar symbol sequence in a region outside of the belt area to form a rendered pattern, the region outside of the belt area being opposite the side having the human-readable bar code information. At the same time, the bar symbols inside the belt area represent information that is machine-readable.

The method above may further comprise varying the length of multiple bar symbols in the bar symbol sequence to form a contour 140 of the rendered pattern in the region outside of the belt area and/or may comprise linking an additional pattern 130 to at least one of the bar symbols in the region outside of the belt area.

In further embodiments, the method may also comprise disconnecting at least one of the bar symbols in the plurality of bar symbols in the region outside of the belt area and/or configuring a color pattern to be read by machine as a background color and linking the color pattern to at least one of the bar symbols in a region inside of the belt area.

In yet further embodiments, the method may further comprise varying a width of a bar symbol in the region outside of the belt area and/or curving or distorting a bar symbol in the region outside of the belt area.

Also contemplated by the invention herein are products and product packages having a design bar code as described above.

The above described embodiments pertain to a single dimensional bar code such as JAN code, EAN code and the like. However, the present invention could be applied to two dimensional bar codes such as QR code or the like. For instance, a two dimensional bar code representing information to be read by a scanner is positioned within a rectangular area of a predetermined size, and by designing the outside region (shape or pattern) that surrounds the rectangular area, the user could perceive the two dimension code and the outside region of rectangular area as a single integrated design.

While several preferred embodiments of the invention have been illustrated and described, it will be appreciated that various changes can be made therein without departing from the spirit and scope of the invention.

The embodiments of the invention in which an exclusive property or privilege is claimed are defined as follows:

1. A design bar code comprising a bar symbol sequence that includes a plurality of bar symbols aligned with spaces therebetween and a side having human-readable bar code information, wherein the bar symbols occupy a belt area and one or more of the bar symbols has a length that extends outside of the belt area, wherein the length of at least one bar symbol in the bar symbol sequence is varied in a region outside of the belt area to form a rendered pattern, the region outside of the belt area being opposite the side having the human-readable bar code information, and wherein the bar symbols inside the belt area represent information that is machine-readable.

2. The design bar code as claimed in claim 1, wherein the length of multiple bar symbols in the bar symbol sequence are varied to form a contour of the rendered pattern in the region outside of the belt area.

3. The design bar code as claimed in claim 1, wherein an additional pattern is linked to at least one of the bar symbols in the region outside of the belt area.

4. The design bar code as claimed in claim 1, wherein at least one of the bar symbols in the plurality of bar symbols is disconnected in the region outside of the belt area.

5. The design bar code as claimed in claim 1, further comprising a color pattern configured to be read by machine as a background color and linked to at least one of the bar symbols in a region inside of the belt area.

6. The design bar code as claimed in claim 1, wherein a width of a bar symbol is varied in the region outside of the belt area.

7. The design bar code as claimed in claim 1, wherein a bar symbol in the region outside of the belt area is curved or distorted.

8. A product or product package having a design bar code attached thereto, wherein the design bar code comprises a bar symbol sequence that includes a plurality of bar symbols aligned with spaces therebetween and a side having human-readable bar code information, wherein the bar symbols occupy a belt area and one or more of the bar symbols has a length that extends outside of the belt area, wherein the length of at least one bar symbol in the bar symbol sequence is varied in a region outside of the belt area to form a rendered pattern, the region outside of the belt area being opposite the side having the human-readable bar code information, and wherein the bar symbols inside the belt area represent information that is machine-readable

9. The product or product package as claimed in claim 8, wherein the length of multiple bar symbols in the bar symbol sequence are varied to form a contour of the rendered pattern in the region outside of the belt area.

10. The product or product package as claimed in claim 8, wherein an additional pattern is linked to at least one of the bar symbols in the region outside of the belt area.

11. The product or product package as claimed in claim 8, wherein at least one of the bar symbols in the plurality of bar symbols is disconnected in the region outside of the belt area.

12. The product or product package as claimed in claim 8, further comprising a color pattern configured to be read by machine as a background color and linked to at least one of the bar symbols in a region inside of the belt area.

13. The product or product package as claimed in claim 8, wherein a width of a bar symbol is varied in the region outside of the belt area.

14. A method of constructing a design bar code, comprising:
preparing a bar symbol sequence that includes a plurality of bar symbols aligned with spaces therebetween and a side having human-readable bar code information, wherein the bar symbols occupy a belt area and one or more of the bar symbols has a length that extends outside of the belt area; and
varying the length of at least one bar symbol in the bar symbol sequence in a region outside of the belt area to form a rendered pattern, the region outside of the belt area being opposite the side having the human-readable bar code information,
wherein the bar symbols inside the belt area represent information that is machine-readable.

15. The method as claimed in claim 15, further comprising varying the length of multiple bar symbols in the bar symbol sequence to form a contour of the rendered pattern in the region outside of the belt area.

16. The method as claimed in claim 15, further comprising linking an additional pattern to at least one of the bar symbols in the region outside of the belt area.

17. The method as claimed in claim 15, further comprising disconnecting at least one of the bar symbols in the plurality of bar symbols in the region outside of the belt area.

18. The method as claimed in claim 15, further comprising configuring a color pattern to be read by machine as a background color and linking the color pattern to at least one of the bar symbols in a region inside of the belt area.

19. The method as claimed in claim 15, further comprising varying a width of a bar symbol in the region outside of the belt area.

20. The method as claimed in claim 15, further comprising curving or distorting a bar symbol in the region outside of the belt area.
